(19) United States
(12) Patent Application Publication
(10) Pub. No.: US 2007/0196545 A1
(43) Pub. Date: Aug. 23, 2007

(54) Holding Device For Ice-Cream Cones And Method For The Use Thereof

(75) Inventor: Ulla Christina Rocha Prazeres, Bronshoj (DK)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: SONNE, DANIELA, DK-2900 HELLERUP (DK)

(21) Appl. No.: 10/593,773

(22) PCT Filed: Mar. 22, 2005
(86) PCT No.: PCT/DK05/00198

§ 371 Date: Sep. 22, 2006

(30) Foreign Application Priority Data
Mar. 23, 2004 (DK) PA 2004 00458

(51) Int. Cl. A21D 13/00

(52) U.S. Cl. 426/139

(57) ABSTRACT

A holding device (4) for ice-cream cones (2) and made of paper, cardboard, plastic or of a laminate thereof, the holding device (4) including a holder part (6) with a circular opening (8) which is adapted for receiving a cornet or a cone (2) with edible ice, for example soft ice, the holding device (4) including a projecting support member (10) at a side of the opening (8), where the support member (10) has a straight edge part (12) spaced a part from the opening (8) and extending perpendicularly relative to a center axis through the support member (10) and the opening (8). With the holding device according to the invention, it is hereby possible to place a cornet or a cone filled with ice-cream, for example soft ice, on a plane base, for example a counter or a table. It is thus necessary to have disposal of current holding devices with a number of holes for accommodating a corresponding number of filled ice cones. In a simple way, the straight edge part of the support member prevents the holding device with a cornet or cone filled with ice-cream from turning over or rolling around.

### BACKGROUND OF THE INVENTION

1. Field of the Invention

The present invention concerns a holding device for ice-cream cones. The invention also concerns a method for using the holding device.

When selling and handling ice-cream cones, for example soft ice, it is often a problem that special cone-holders are to be used if the filled ice-cream cones cannot be handed over successively to the customer or receiver.

The invention is a new and improved holding device of the kind specified in the introduction, and which in a simple way enables placing a cone or a cornet filled with ice, for example soft ice, on a plane base, for a counter or a table.

2. Description of the Invention

The holding device according to the invention is has a projecting support member at a side of the opening, the support member designed with a straight edge part which is spaced apart from the opening and extends perpendicularly relative to a center axis through the support member and the opening. In a simple way and by means of the holding device according to the invention it is hereby possible to place a cornet or a cone filled with ice-cream, for example soft ice, on a plane base, for example a counter or a table. It is thus necessary to have disposal of current holding devices with a number of holes for accommodating a corresponding number of filled ice cones. The straight edge part of the support member prevents in a simple way the holding device with a cornet or cone filled with ice-cream from turning over or rolling around.

Suitably, the holding device according to the invention may be made double in such a way that it includes two uniform sides that are continuous and bent about the straight edge part, that is the holding device includes two continuous support members and two mutually separated uniform holder parts with two circular openings disposed opposite each other.

Preferably, the holding device according to the invention is designed so that the holder part essentially is shaped as a ring which at one side is connected with the support member or the support members.

Advantageously, the holding device according to the invention may furthermore be designed so that the support member or support members are designed with side edges extending with a convex curving shape from opposed ends of the straight edge part towards the annular holder part or holder parts.

The invention furthermore is a method for using the holding device according to the invention in connection with a cornet or a cone for edible ice, for example soft ice, the method comprising:

enveloping a cornet or cone by a napkin;

passing the holder part of a holding device around the napkin and securing it externally of the cornet or cone;

filling ice-cream or soft ice into the cornet or in the cone; and

preferably placing the filled cornet or the filled cone on a flat base supported by the support member of the holding device.

The method according to the invention may include additional steps: placing a piece of chocolate, a piece of candy and/or a towelette is placed in the double support member in such a way that the item in question projects outside the sides of the support member.

### BRIEF DESCRIPTION OF THE DRAWINGS

The invention is described more closely in connection with the drawing, on which:

FIG. 1 shows a cornet or a cone;

FIG. 2 shows a plan view of an embodiment of a holding device according to the invention;

FIG. 3 shows a perspective view of a holding device according to the invention disposed on a cornet or an ice-cream cone;

FIG. 4 shows a second embodiment of a holding device according to the invention;

FIG. 5 shows a perspective of an ice-cream cone with a napkin which is fixed externally of the ice-cream cone by means of a holding device according to the invention;

FIG. 6 shows a perspective view of an ice-cream cone, cf. FIG. 4, which is filled with soft ice.

FIG. 7 shows a plan view of a third embodiment of a holding device according to the invention;

FIG. 8 shows a perspective view of a fourth embodiment of a holding device according to the invention;

FIG. 9 shows a perspective view of a fifth embodiment of a holding device according to the invention; and

FIG. 10 shows a perspective view of a sixth embodiment of a holding device according to the invention.

### DETAILED DESCRIPTION OF THE INVENTION

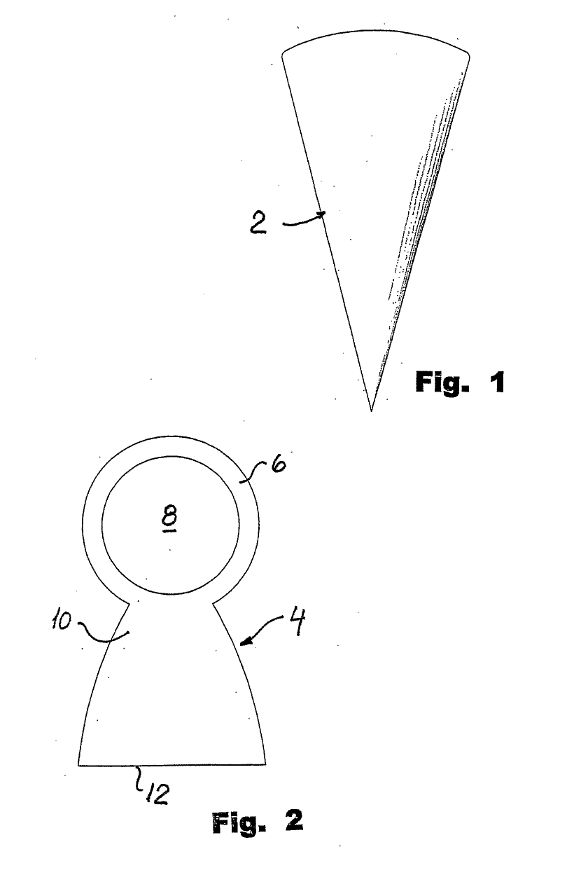

In FIG. 1 is shown a cornet or an ice-cream cone 2, while FIG. 2 shows a holding device 4 with a holder part 6 with a circular opening 8 for accommodating a cornet or a cone 2 and a support member 10 projecting form the holder part 6 and provided with a straight edge part 12 spaced apart from the holder part 6 and with side edges 14 extending with a convex curving shape from opposed ends of the edge part 12 towards the holder part 6.

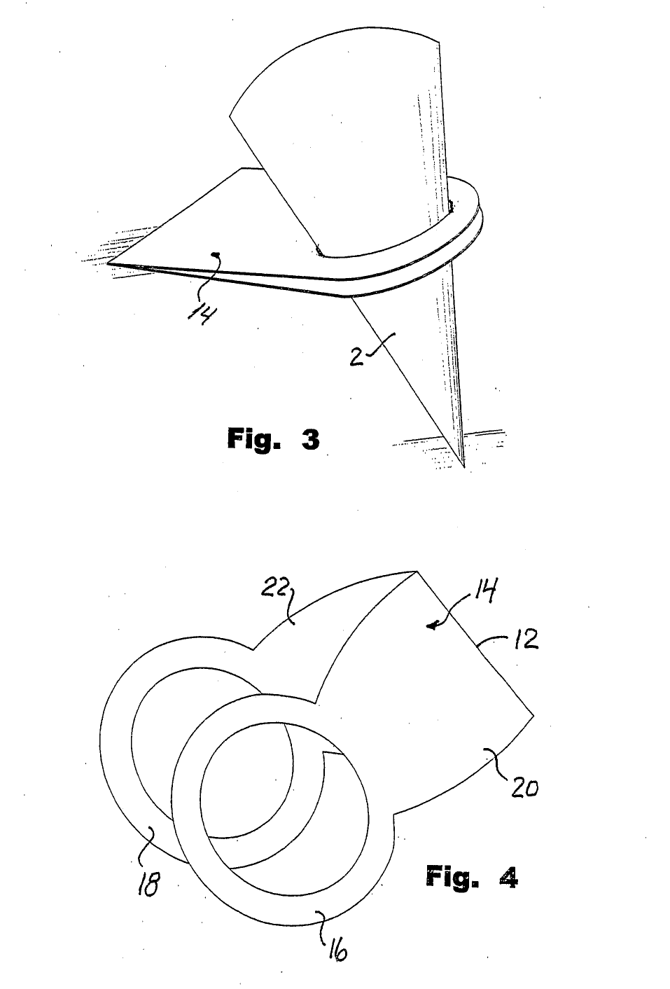

In FIG. 3 is shown how a double embodiment of a holder device 14 is mounted externally of the cornet or cone 2, so that it by itself may be supported at an inclining position on a plane surface, for example a counter or a table.

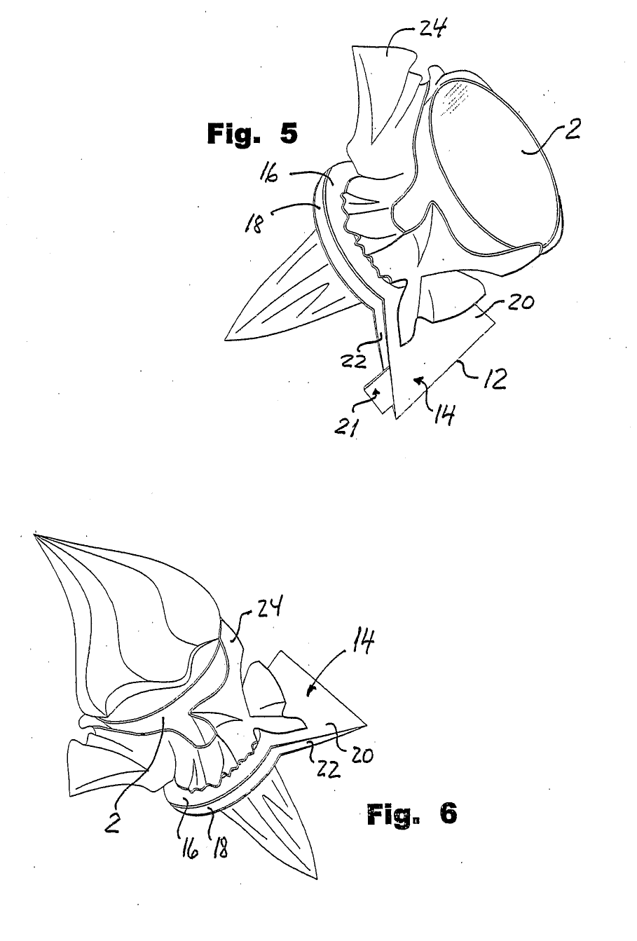

FIG. 4 shows a double embodiment of a holding device 14 which is bent along the common straight edge 12, that is the holding device 14 has two uniform holder parts 16, 18 and of two uniform continuous double support members 20, 22, which, as shown in FIG. 5, may be used for holding a piece of chocolate 21, a piece of candy or a towelette.

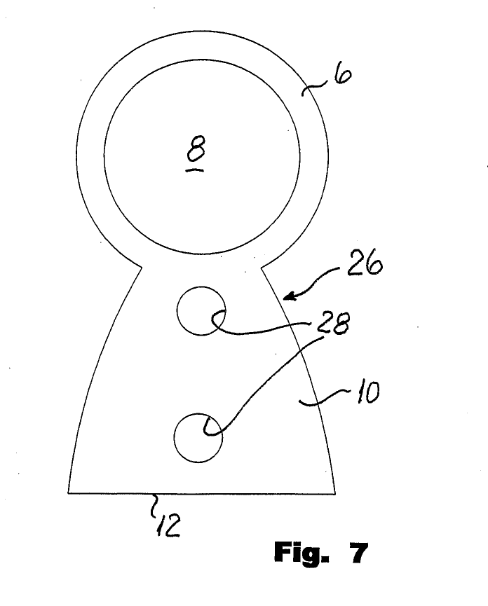

In FIG. 5 is furthermore shown how the ice cone 2 may be enveloped by a napkin 24 which is fixed externally on the ice cone 2 by means of the holding device 14. that is the ice cone 2 is now ready to be filled with ice-cream, that is soft ice. FIG. 6 shows the filled ice cone 2 mounted with a napkin 24 which is fixed externally of the ice cone 2 by means of the holding device 14. In a good way is hereby avoided spilling too much ice-cream down over hands and arms. By means of a ice cone holder according to the invention one is provided the option of putting the ice-cream cone aside instead of asking someone else to hold the ice.

FIG. 7 shows a third embodiment of a holding device 26 largely corresponding to the holding device 4 cf. FIG. 2, but where the support member 10 is designed with two circular holes 28 intended for receiving and fixing an elongated item, for example a disposable teaspoon of plastic, which is passed through both holes 28.

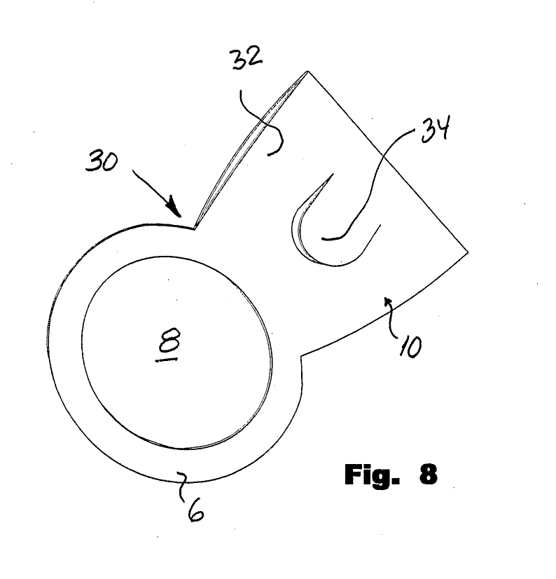

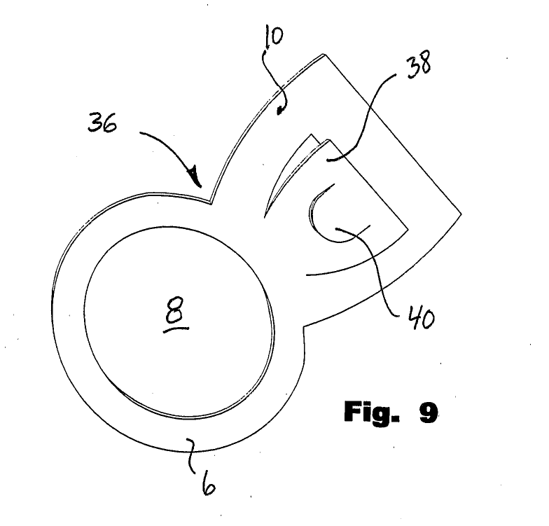

The holding device 30 shown in FIG. 8 is provided with a double-walled support member 10 which in a front wall part 32 is provided with a holder flap 34 intended for fixing an item which in that case extends transversely of the support member 10 at both sides of the holding flap 34. The double-walled support member 10 may, similar to the double support members 20, 22 compare FIGS. 3-6, serve to receive and fix an item, for example a piece of candy, a piece of chewing gum or a piece of chocolate.

In the holding device 36 shown in FIG. 9, a support member 10 is designed with a primary holding flap 38 which in turn is designed with a lesser secondary holding flap 40, where the holding flaps 38, 40 may serve to secure for example one or more pieces of candy or the like.

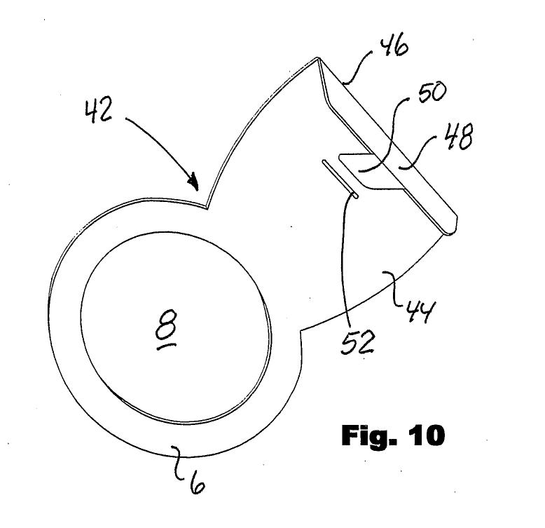

In the holding device 42 shown in FIG. 10, a support member 44 along a straight edge part 46 is designed with an extension in the shape of a bent wing part 48 which by means of a central wing tongue 50 may be fixed in a central holding slot 52 in the support member 44, so that an item, for example a piece of candy, a piece of chewing gum or a piece of chocolate may be secured between the support member 44 and the wing part 48.

1. A holding device for ice-cream cones made of paper, cardboard, plastic or of a laminate thereof, the holding device including a holder part with a circular opening for receiving a cornet or a cone with edible ice, wherein the holding device includes a projecting support member at a side of the opening, the support member comprising a straight edge part which is spaced apart from the opening and extending perpendicularly relative to a center axis through the support member and the opening.

2. A holding device according to claim 1, including two uniform sides that are continuous and bent about the straight edge part, the holding device including continuous support members and uniform holder parts with circular openings disposed opposite each other.

3. A holding according to claim 1 wherein the holder part is shaped as a ring which at one side is connected with at least one of the support members.

4. A holding device according to claim 1 wherein the at least one support member includes side edges extending with a convex curving shape from opposed ends of the straight edge part towards the annular holder part or holder parts.

5. A holding device according to claim 1, wherein the support member includes holes for accommodating and fixing an elongated item, which is passed through both holes.

6. A holding device according to claim 1, wherein a double-walled support member is provided in a front sidewall with a holding flap fixing an item extending transversely of the support member at both sides of the holding flap.

7. A holding device according to claim 1, wherein the support member includes a primary holding flap including secondary holding flap, the holding flaps being for holding at least one piece.

8. A holding device according to claim 1, comprising a support member along a straight part which is a bent wing part with a central holding tongue for fixing in a central holding slot in the support member, so that an item, can be fixed between the support member and the wing part.

9. A method for applying a holding device for ice-cream cones made of paper, cardboard, plastic or of a laminate thereof, the holding device including a holder part with a circular opening for receiving a cornet or a cone with edible ice, wherein the holding device includes a projecting support member at a side of the opening, the support member comprising a straight edge part which is spaced apart from the opening and extending perpendicularly relative to a center axis through the support member and the opening with a cornet or a cone for edible ice or ice cream, the method comprising:
enveloping a cornet or cone by a napkin;
passing a holder part of a holding device up around the napkin and securing the napkin externally of the cornet or cone;
filling ice-cream or soft ice the cornet or in the cone; and
placing the filled cornet or the filled cone on a flat base supported by the support member of the holding device.

10. Method according to claim 9, comprising:
placing a piece of chocolate, a piece of candy and/or a towelette in the support member so that the item projects outside the sides of the support members.

11. A holding according to claim 2 wherein the holder part is shaped as a ring which at one side is connected with at least one of the support members.

12. A holding device according to claim 2 wherein the at least one support member includes side edges extending with a convex curving shape from opposed ends of the straight edge part towards the annular holder part or holder parts.

13. A holding device according to claim 3 wherein the at least one support member includes side edges extending with a convex curving shape from opposed ends of the straight edge part towards the annular holder part or holder parts.

14. A holding device according to claim 2, wherein a double-walled support member is provided in a front sidewall with a holding flap for fixing an item extending transversely of the support member at both sides of the holding flap.

15. A method according to claim 9 wherein the holding device with a cornet or a cone for edible ice or ice cream, comprising:
enveloping a cornet or cone by a napkin;
passing a holder part of a holding device up around the napkin and securing the napkin externally of the cornet or cone;
filling ice-cream or soft ice into the cornet or in the cone; and
placing the filled cornet or the filled cone on a flat base supported by the support member of the holding device.

16. A method according to claim 9 wherein the holding device comprises the holder part being shaped as a ring which at one side is connected with at least one of the support members.

17. A method according to claim 9 wherein the at least one support member includes side edges extending with a convex curving shape from opposed ends of the straight edge part towards the annular holder part or holder parts.

18. Method according to claim 15, comprising:
placing a piece of chocolate, a piece of candy and/or a towelette in the support member so that the item projects outside the sides of the support members.

19. Method according to claim 16, comprising:
placing a piece of chocolate, a piece of candy and/or a towelette in the support member so that the item projects outside the sides of the support members.

20. Method according to claim 17, comprising:
placing a piece of chocolate, a piece of candy and/or a towelette in the support member so that the item projects outside the sides of the support members.
